(19) United States
(12) Patent Application Publication
(10) Pub. No.: US 2017/0135323 A1
(43) Pub. Date: May 18, 2017

(54) MULTI-USE BEEHIVE

(71) Applicant: Aristos GEROGIANNIS, Aspropyrgos, Attikis (GR)

(72) Inventor: Aristos GEROGIANNIS, Aspropyrgos, Attikis (GR)

(21) Appl. No.: 15/322,786

(22) PCT Filed: Jul. 3, 2015
(86) PCT No.: PCT/GR2015/000033

§ 371 Date: Dec. 29, 2016

(30) Foreign Application Priority Data
Jul. 8, 2014 (GR) 20140100372

(51) Int. Cl. A01K 47/06; A01K 53/00

(52) U.S. Cl. CPC A01K 47/06; A01K 53/00

(57) ABSTRACT

The invention relates to a multi-use beehive, which consists of a base (1), a deck (2), an inner supplier (3), a queen partition (22) and a lid (4). The base (1) has spacers (7), flying boards (8) for the bees and a perforated floor (12). The deck (2) consists of two parts (14), (15) with an inner insulation (18) and a connection flange (5). The inner supplier (3) has a pan (25) and grid (26) for receiving liquid and solid feed respectively, while the queen partition (22) allows accommodation of the queen. Finally, the lid (4) has also an insulation (18) and aeration ports (6). The beehive is made of plastic and its parts comprise holes for the assemblying thereof by means of pins (19).

### FIELD OF THE INVENTION

The invention relates to the field of the art of novel beehives and in particular to a plastic multi-use beehive suitable for the generation and maintenance of one or more bee swarms.

### BACKGROUND OF THE INVENTION

The multi-use beehive proposed herein has not be disclosed in the prior art.

Although art has developed in all levels, bee-keeping still employs old, traditional methods. Bee-keepers still employ traditional breeding methods for the swarms, and the beehives are manufactured in the old way. In essence, beehives have not been subjected to any improvements, maintaining the same shape and the same manufacturing materials. As a result, most bee-keepers still employ wooden beehives, which they must maintain, clean and paint, and their lifetime is particularly limited. Furthermore it is known that the wooden beehives are not suitable for transport and they do not accommodate the swarm efficiently, nor do they have suitable mechanical strength.

As it is known to the skilled in the art, a beehive usually consists of a deck, a base, a supplier and a lid. In usual variations, a beehive may also have, additionally to the above elements, a pollen trap and a partition. All the above are made of wood and exhibit inherent problems and disadvantages. The base of a beehive, being wooden, rots, is frequently affected by fungi, microbes and other pathogenic microorganisms, and it usually has a screw configuration for mounting on the remaining beehive, thereby inhibiting its removal, when that is necessary.

Furthermore, the deck of a beehive frequently needs painting of its interior, as it is also sensitive to microbes and pathogenic microorganisms. Also, the manufacturing material does not provide insulation to temperature variations, causing stress to the swarm.

The supplier is usually wooden or plastic and allows supplying only liquid feed to the beehive. Bee-keepers are frequently forced to find various solutions, including the use of plates and other means, on which they place solid feed for the bees• however, as it is apparent, the specific solution is far from ideal. It should be also mentioned that the available supplies do not have the necessary shoulder, thus the bees are not suitably aerated and their free movement during feeding is inhibited.

Another disadvantage of the available beehives relates to the partitions, which do not have an entrance-exit gate on the second deck, nor do they have protrusions to allow the bees to fly away and land on the beehive. Another disadvantage of the available partitions is that it does not allow two female bees in the same beehive. Previously, even if they were separated one from the other, due to the inherent problems of the specific partitions, the one queen did manage to come in contact with the other, leading to the extermination of the one or both queens.

Finally, regarding to the lids of the commercially available beehives, these are usually wooden with the metal covering, which affects the micro-climate of the beehive, since there are large temperature variations, and as a result the number of the bees of every swarm is respectively affected. Furthermore, lids frequently have openings with screens, so that the aeration of the bees is facilitated during summer, and it is not uncommon that the screens wear so that undesirable bugs enter the beehive. It should be noted that the main source of contamination of a beehive is its lid, since moisture usually accumulates on the ceiling of the beehive which allows growth of fungi and other pathogenic microorganisms, and also the specific component rots and wears easily, forcing the bee-keepers to execute continuous maintenance work and frequent replacements.

It is an object of the present invention to address the above disadvantages and defects of the prior art by proposing a plastic multi-use beehive, which will be made of durable materials, will protect the swarm both against outer conditions and against temperature variations, since it has double walls and suitable heat-insulation, while at the same time it requires minimal or no maintenance.

A further object of the present invention is to provide a multi-use beehive, which will provide large safety during transport of the bees, since it has safety pins which prevent displacement of its components.

A further object of the present invention is to provide a beehive that is assembled from different parts, in many different ways, so that the respective desired purposes of the individual bee-keeper. In this way, honey may be produced by a bee swarm, two or three swarms may be grown in the same beehive, queen breeding and royal jelly production are effected.

It is a further object of the present invention to provide a beehive that keeps a constant temperature, thereby facilitating the bee to live under suitable living and reproduction conditions.

A further object of the present invention is to provide a multi-use beehive, which does not require frequent maintenance and does not have a limited lifetime, but which can be maintained in a simple manner, decontaminated easily, as well as it is made of plastic materials suitable for foodstuffs.

The specific invention is further advantageous due to the provision of a special flange which reinforces its mechanical properties, preventing any deformations, while it keeps the shape of the beehive constant and square.

A further object of the invention is the provision of a plastic lid, which prevents accumulation of moisture at the upper part of the beehive, while it also has 4 ports for its proper aeration. Thus, rotting as well as infection of the swarm by fungi and other pathogenic parasites are prevented.

These and other objects, features and advantages of the invention will be fully understood by the following detailed description.

### BRIEF DESCRIPTION OF THE DRAWINGS

The invention will be apparent to those skilled in the art with reference to the accompanying figures, in which the invention is depicted in an exemplary non-limiting way.

FIG. 1 shows in perspective view an exemplary construction of the multi-use beehive with its components. The base, the deck with its flange, the inner supplier as well as the lid with the aeration ports are shown.

FIG. 2 shows how the 2 parts of the deck of the beehive are clamped on the central fastening flange, which has transport incisions.

FIG. 3 shows a multi-use beehive with two decks, in which two, three or more swarms may be grown.

FIG. 4(a) shows a side view of the beehive, where apart from the two plastic parts, the flange and its connection screws are shown. The insulation in the walls is shown, which allows efficient heat-insulation of the bee-hive. FIG. 4(b) also shows the inner fittings used during assembling of the beehives.

FIG. 5 shows the base of the beehive with spacers and flying boards for the bees, while FIG. 6 shows in cross-section part of the perforated base.

FIG. 7 shows the lid of the beehive with the aeration ports and the snapping points for secure positioning of one beehive on another, so that unobstructed transport thereof is achieved.

FIG. 8(a) shows in perspective view the lid of the beehive, showing its insulation points, while FIG. 8(b) shows how the two parts constituting the beehive lid are connected by means of screws.

FIG. 9 shows an entrance-exit port on the beehive, which allows the bees to enter, while it prevents any larger bug from entering. Also, during transport it closes its slidable, perforated cover, accommodating the swarm in the beehive.

FIG. 10 shows the partition, which may be used in various ways in the beehive, depending on the needs of a bee-keeper.

FIG. 11 shows the assembling of a two-deck beehive by the use of metal anchors.

### DETAILED DESCRIPTION OF A PREFERRED EMBODIMENT

Referring now to the accompanying figures, illustrative embodiments of the multi-use beehive will be described and the features and advantages thereof will be shown in relation to the known beehives.

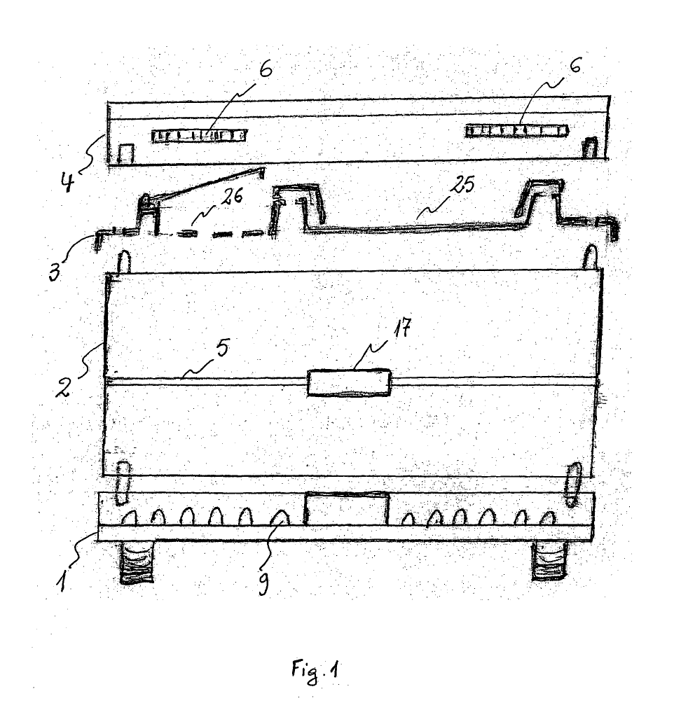

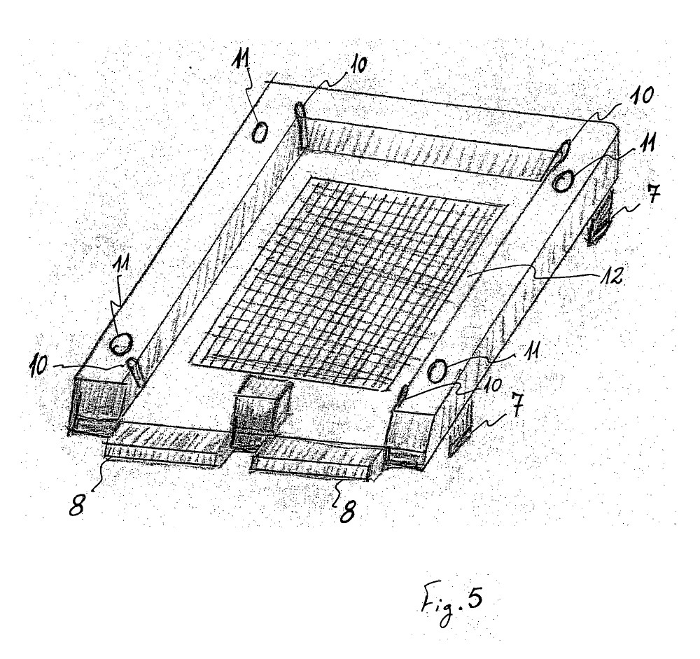

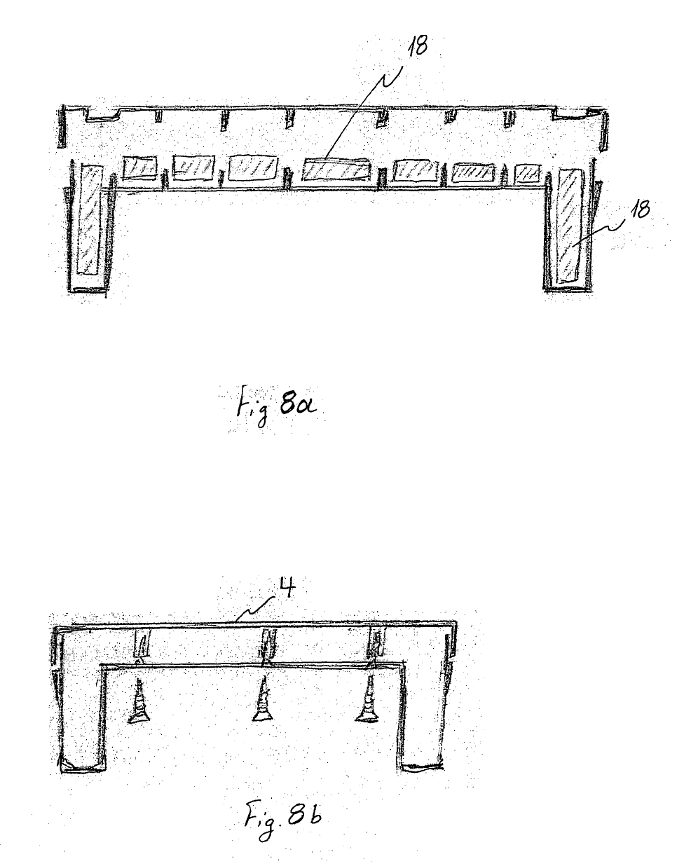

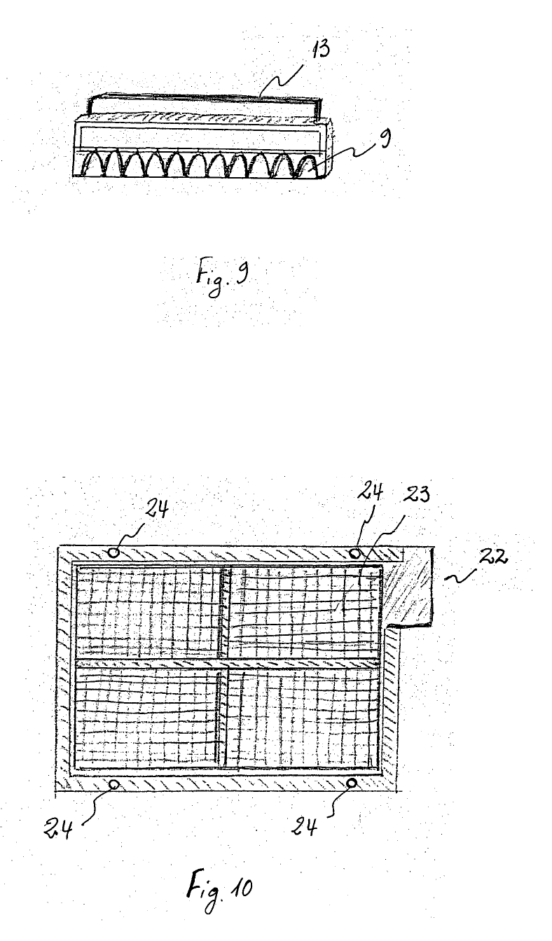

The multi-use beehive, FIG. 1, consists of a base (1), a deck (2), a connection flange (5), an inner supplier (3) and a lid (4) with aeration ports (6). Between the two decks (2), a queen partition (22), FIG. 10, may be arranges, however this can also be arranged when more than one deck are present. The base (1), FIG. 5, is made of plastic, preferably polypropylene, as the whole multi-use beehive. The base has spacers (7) so that it is positioned on the ground, without coming in contact with that. In this way, the beehive is protected against parasites or organisms of the ground that may affect the beehive. On its front part, the beehive has flying boards (8), exemplarily two are shown, without their number being limited to that, allowing the bees to fly from, and return to, the beehive. The entrance is protected by entrance-exit ports (9), FIG. 9, which have dimensions such that they allow unobstructed motion of the bees, but at the same time they block the entrance against other bugs or insects, which may be harmful for the beehive. During transport, a perforated plastic cover (13) is fitted, blocking the entrance and exit of the bees, and allowing at the same time the aeration thereof.

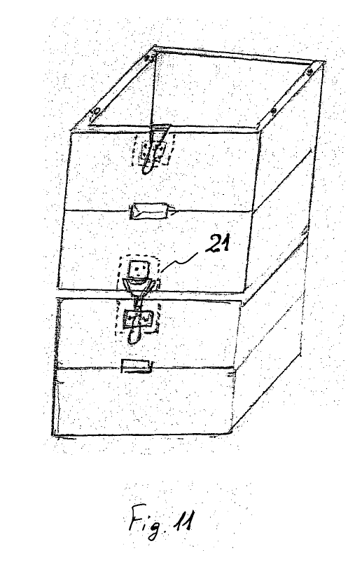

The base (1) has pins (10) and pin sockets (11), by means of which it is fitted on the deck (2) of the beehive. The floor (12) thereof may be perforated, allowing aeration of the beehive, keeping a healthy environment for the bees, and allowing removal of the bee secretions, and on the other side blocking harmful elements from entering from the lower part of the beehive. It is clear that when required, for example due to weather conditions, the floor (12) of the base (1) can be internally covered by a cover, blocking aeration of the beehive. It should be noted that the base (1) may be connected to the floor (2) of the beehive by means of metal anchors (21), FIG. 11, or of other suitable means, ensuring the stability of the multi-use beehive as a whole.

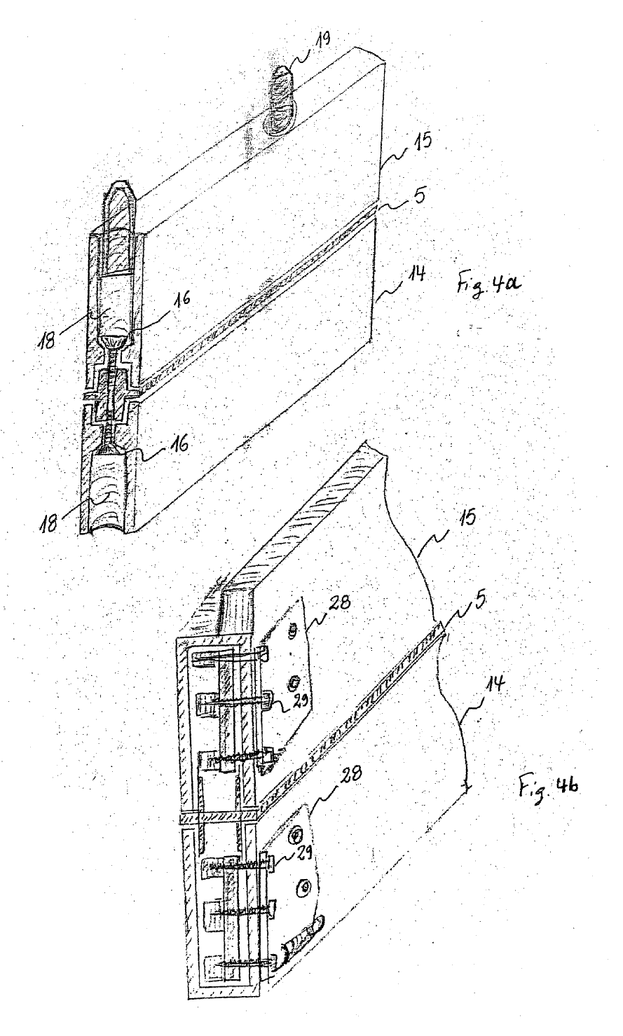

Each floor (2) consists essentially of two plastic parts, preferably mace of polypropylene copolymer, which is suitable for food applications. The lower part (14) and the upper part (15), FIG. 4(a), are connected between them by a connection flange (5). The connection flange (5) aids in keeping the rectangular shape of the beehive, without this being subjected to deformations during transport or during use in general. The connection flange (5) is connected by means of screw (16) on the two parts (14), (15) of the floor (2). Also, the connection is reinforced by the use of inner fittings (28), FIG. 4(b), which are metal components positioned during assembling of the two parts (14), (15) of the beehive on the inner part between two walls, at the points where the metal anchors are to be positioned (21). The inner fittings (28) are screwed on the parts by the use of screws (29), six per side, without this limiting the use of more or less screws. In this way, the mechanical strength at the points of the beehive are increased, so that this may receive the tightening screws of the metal anchors (21).

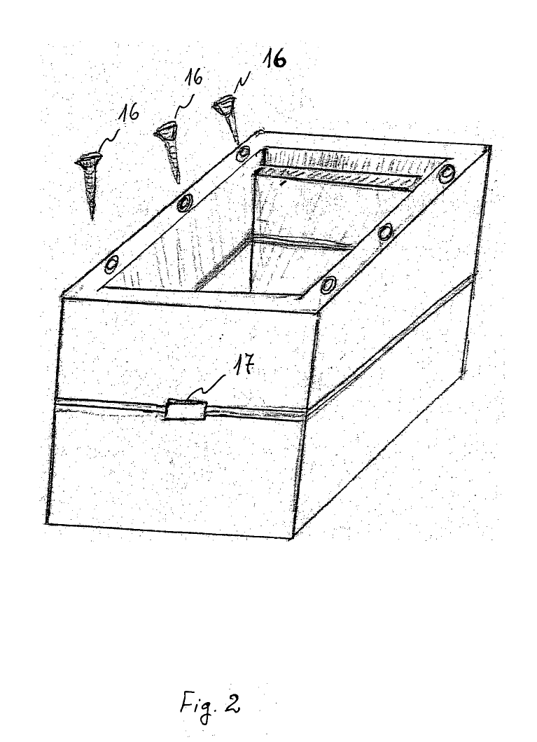

The manufacturing material of the connection flange (5) may be metal, acrylonitrile, butadiene, styrene, known as ABS, polypropylene, or any other suitable material that can retain its shape and form despite the applied stresses. The connection flange (5), as shown in FIG. 2, has an incision (17) both at its front and at its rear part, allowing easy transport of the assembled beehive, since they operate as transport handles.

The lower part (14) and the upper part (16) have insulation (18) in their interior, made of suitable material, so that they present the necessary heat-insulation properties that will allow the proper and unobstructed growth of the swarm. Exemplarily, it is mentioned that the material used may be expanded polystyrene or polyurethane, as well as any other suitable material with the above-mentioned properties.

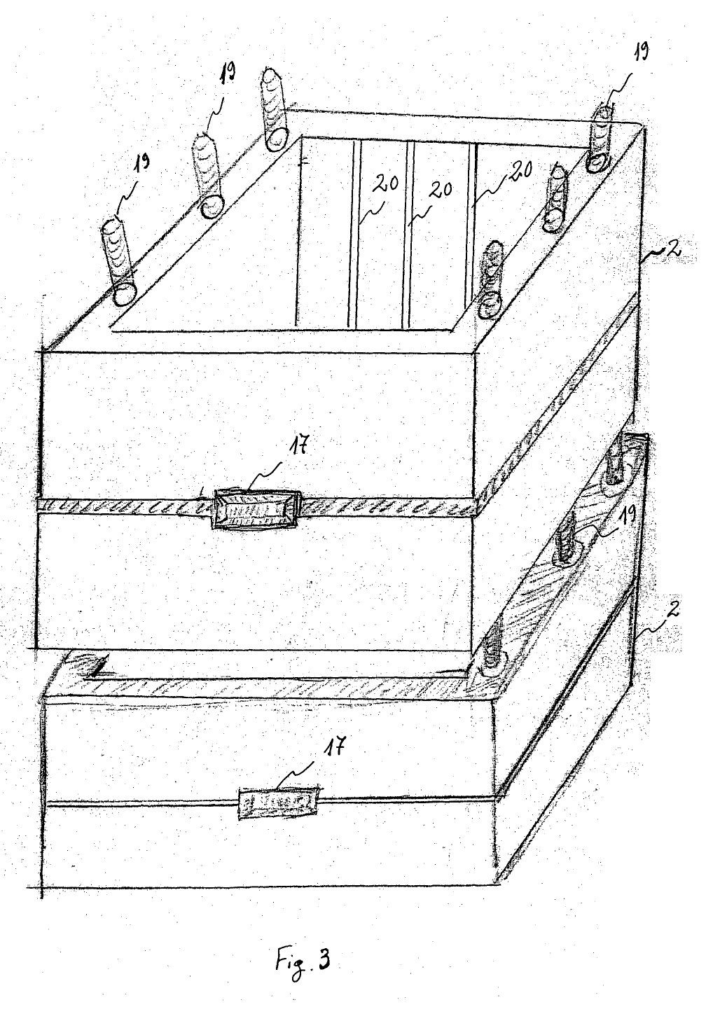

In the holes, where screws (18) are positioned, safety pins (19), FIG. 3, may be arranged, which will be used for snapping the various parts of the multi-use beehive between them. In this way, stability and safety of the beehive are ensured during transport. Exemplarily, as it is shown in FIG. 3, the safety pins (19) may be employed to connect two or more decks (2) between them, forming a larger beehive, with more bees for more efficient honey production, or they may be employed to connect the deck (2) with the base (1) and the inner supplier (3), FIG. 1.

Each floor (2) has in its inner part 3 pairs of grooves (20), FIG. 3, in which suitable plastic partitions. The plastic partitions are used for the formation and growth of more than one bee swarm, in the same beehive. Until now, that has not been possible. If a vertical partition is mounted in the central groove (20) of the beehive, this will be divided in two equal parts, while by positioning 2 bee-blocking suppliers at the upper part, two different swarms with their queens may be developed, without any danger for the two swarms. Respectively each swarm may enter through the base (1) of the beehive, through different ports (9), left and right of the base (1), since the bees can recognize the point through where they came out of their beehive, on the basis of the sun or the geography of the space. If the bee-keeper desires, two vertical partitions may be positioned in the grooves (20) of the beehive, partitioning the multi-use beehive in three equal parts, and by positioning at their upper part 3 bee-blocking suppliers, this can accommodate different bee swarms with their queens. In this way, three smaller swarms may be combined in a single beehive, which aids in maintaining the micro-climate of the beehive, since each swarms has a smaller available space, while at the same time easier growth of each swarm is allowed.

Between two decks (2) of a multi-use beehive, a queen partition (22) FIG. 10), may be positioned, which has many and different operations, depending on the case. The queen partition (22) consists of a plastic construction, of a thickness of at least 14 mm, without this preventing the use of a thicker partition. On its front part, it has a protrusion (2), which facilitates the bees during their smooth exit from the beehive, while at the same time it aids them during their return when these are loaded. The queen partition (22) has cross-sections (23) of such size that allow free motion of the beehives, blocking however the queen from pasting from the one part of the beehive to the other. At the same time, its positioning is effected between the decks (2), due to its holes (24) in which the pins (19) are inserted. In an exemplary embodiment of the queen partition (22), the bee-keeper may keep the queen in a part of the beehive, so that the queen may lay eggs, while the remaining part of the beehive is used for the production of honey by the worker bees.

In another exemplary embodiment of the specific queen partition (22), in a two-deck beehive (2), this may be covered by solid plastic, so that propagation of the odour of the queen from the one deck to the other through the cross-sections (23) is inhibited, leading the swarm to the growth of a new queen. This may be applied as desired by the bee-keeper in order to renew the swarm or to see queens.

Furthermore, in another exemplary embodiment of the queen partition (22), if the solid plastic has a small hole, this can be employed for the gradual combination of two different swarms to a single swarm. This is achieved since through the small hole a small number of bees passes from the one part of the beehive to the other, allowing the two swarms to become accustomed to the different odours and thus to co-exist, when the queen partition (22) is removed.

Finally, due to the queen partition (22) and the distance formed by its width, in an exemplary embodiment of the multi-use beehive, two queens may co-exist in the same beehive. As it is known this was not possible until now, since if two queens co-exist in a beehive, the stronger one will prevail. If however a queen partition (22) is arranged, and the two queens with their swarms are placed on both sides thereof in the beehive, then there will be no danger, since due to its design, the queens will not be able to pass through the cross-sections (23), while at the same time its thickness is such that it blocks them from coming in contact and exterminate one another. This is an ideal solution for the growth of two swarms in a single beehive, doubling the number of the bees and generating a number of collector bees that will increase honey collection during blossom time.

The inner supplier (3) may be any suitable commercially available device, in which a bee-keeper may place liquid and solid feed for his bees. The liquid is placed in the pan (25), FIG. 1, while the solid feed is placed on a perforated plastic grid (26), through which the bees may pass and obtain their solid feed. The specific construction does not preclude the use of any other way suitable to supply the bees with the necessary feed for the swarm, while it does not prevent the use of more than one, when this is required due to the presence of more swarms in the same beehive.

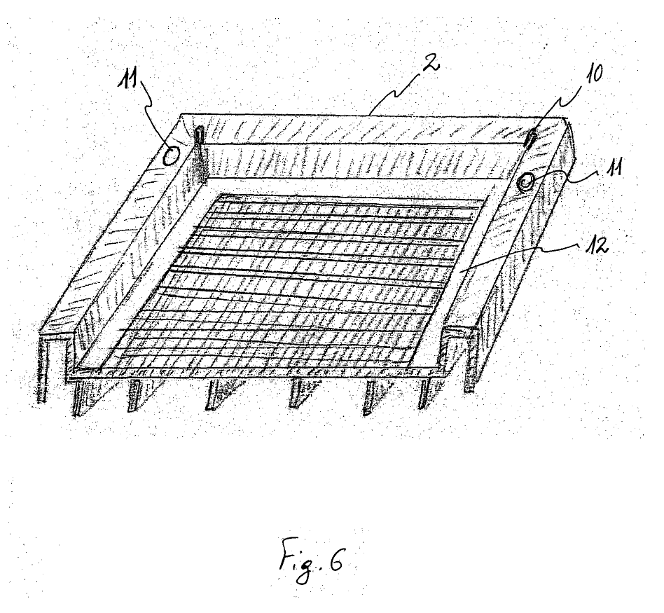

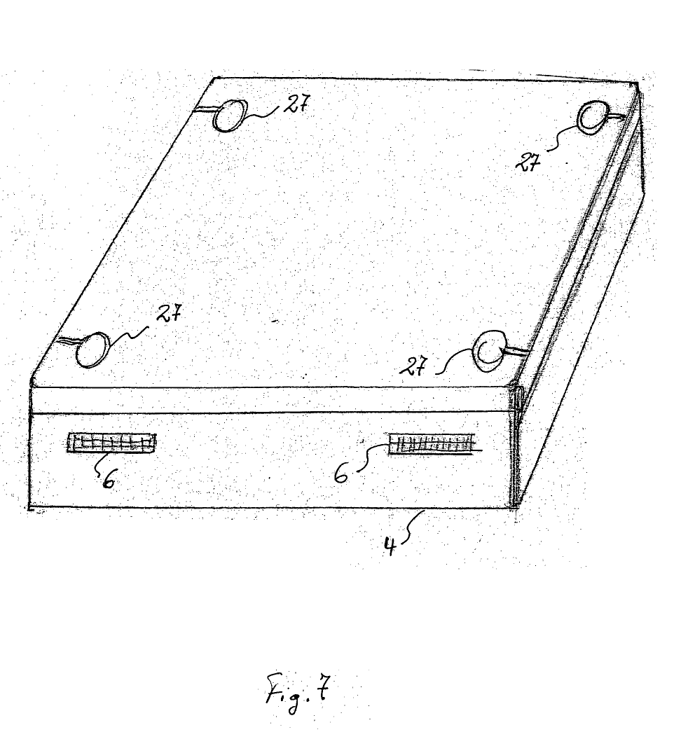

The beehive is closed with a lid (4), FIG. 7, which has aeration ports (6). The lid of the multi-use beehive is also made of a suitable plastic, as the remaining beehive, while it consists of two parts, as it is shown in FIG. 8(a). Between the parts, a suitable heat-insulation material (18) is positioned, as on the deck (2), for the protection of the bees and the wax in the beehive. The two parts are screwed between them, as it is shown in FIG. 8(b), so that the lid (4) is formed. The lid (4) has at its upper part sockets (27), which correspond to the spacers (7) of the base (1), so that when the multi-use beehives are positioned one on top of the other, they can be transported more safely. At the same time, at the front and rear part of the lid (4), there are aeration ports (6) with small cross-sections so that the aeration of the beehive is easier. The lid (4) has such a height so that it will allow the positioning of any suitable inner supplier (3), without inhibiting the motion of the bees, which receive solid or liquid feed therefrom. Finally, it should be mentioned that the connection of the lid (4) with the deck (2) is effected, as mentioned hereinabove, by the use of holes on the lid (4), so that the pins (19) protruding from the deck (2) are fitted. In this way, the safety and stability are ensured during transport of the beehive.

It should be noted that the description of the invention was made with reference to exemplary non-limiting embodiments. Thus, any variation or modification as regards the shape, dimensions, morphology, construction and assemblying materials and components employed, as long as not contributing to the technical advance of the already known are considered as encompassed in the scope of the present invention.

1. A multi-use beehive characterized in that it consists of
a base (1) with spacers (7), flying boards (8) for the entrance and exit of the bees and a perforated floor (12),
a deck (2) consisting of two parts (14), (15) with an inner insulation (18), which are connected by a connection flange (5), for the maintenance of the structural stability of the construction,
an inner supplier (3) with a pan (25) and a perforated grid (26) for receiving liquid and solid feed respectively,
a perforated queen partition (22) with cross-sections (23) for the free motion of the bees, but not of the queen, and
a lid (4) with aeration ports (6), which also comprises an insulation (18).

2. A multi-use beehive according to claim 1, characterized in that the base (1), the deck (2), the inner supplier (3), the queen partition (22) and the lid (4) are connected between them by safety pins (19) which fit in the holes included in each one of them.

3. A multi-use beehive according to claim 1, characterized in that it is made of a polypropylene copolymer.

4. A multi-use beehive according to claim 1, characterized in that the deck (2) comprises grooves (20) along its length, allowing the positioning of one or more partitions to divide the beehive and allowing the growth of more than one swarm therein.
